(19) United States
(12) Patent Application Publication
(10) Pub. No.: US 2014/0307092 A1
(43) Pub. Date: Oct. 16, 2014

(54) HEADLINER INTEGRATED WITH CAMERA OF BLACK BOX FOR VEHICLE

(71) Applicant: Daehan Solution Co., Ltd, Incheon (KR)

(72) Inventor: Choong Ho KWON, Seoul (KR)

(73) Assignee: Daehan Solution Co., Ltd, Incheon (KR)

(21) Appl. No.: 13/949,647

(22) Filed: Jul. 24, 2013

(30) Foreign Application Priority Data
Apr. 16, 2013 (KR) 10-2013-0041667

(51) Int. Cl. B60R 11/04

(52) U.S. Cl. CPC B60R 11/04
USPC 348/148

(57) ABSTRACT

A camera and a black box for a vehicle are accommodated in the headliner to minimally expose the black box to the inside of the vehicle, preventing robbery of or damage to the black box and not spoiling the interior design of the vehicle.

A headliner is integrated with four cameras installed at corners of the headliner to photograph required videos in front and rear, and both sides of the vehicle, obtaining videos of surroundings of the vehicle.

In addition, provided is a headliner integrated with a camera of a black box for a vehicle capable of photographing videos of surroundings of the vehicle and the inside thereof using the camera of the black box and thus simultaneously obtaining a basic function of the black box and a function of observing the inside of the vehicle.

The black box is installed at the headliner.

### CROSS-REFERENCE TO RELATED APPLICATION

This application claims priority to and the benefit of Korean Patent Application No. 10-2013-0041667, filed Apr. 16, 2013, the disclosure of which is incorporated herein by reference in its entirety.

### BACKGROUND

1. Field of the Invention

The present invention relates to a headliner integrated with a camera of a black box for a vehicle, and more particularly, to a headliner in which a camera of a black box is mounted and capable of minimizing exposure of the black box to the inside of a vehicle to improve appearance of the interior and concealing the camera from the outside of the vehicle to prevent robbery and damage thereof.

2. Discussion of Related Art

In recent times, many vehicles are equipped with car running data recorders (referred to as “a black box”). Such a black box photographs surroundings of the vehicle using a camera thereof, and records the photographed videos for a certain time, which are used as evidential data upon a traffic accident.

Such black boxes are classified as 1-channel, 2-channel, and 4-channel black boxes according to the number of cameras. The 1-channel black box photographs a scene in front of a vehicle using one camera, and the 2-channel black box photographs scenes in front and rear of a vehicle. In many cases, the 4-channel black box has cameras mounted at corners of the inside of a vehicle to photograph scenes in front and rear of the vehicle and the inside thereof.

However, since the black box is not a necessary component, most car buyers individually buy black boxes and mount the block boxes in vehicles after the vehicles are delivered. For this reason, the black boxes have the following problems.

(1) Since the black box separately produced from the vehicle is bought and mounted in the vehicle, the black box cannot be in harmony with the interior of the vehicle and is exposed to the interior to spoil the interior design.

(2) In particular, since the black box is installed at a console box, a tray, or the like, to photograph scenes in front and rear of the vehicle, installation of the black box can be readily seen from the outside of the vehicle, increasing probability of robbery and loss.

(3) While the 4-channel black boxes are widely used due to a wide photographing angle and clear image quality, the 4-channel black box is expensive and cannot be easily installed therein. Moreover, when the camera of the black box is installed at the outside of the vehicle, probability of robbery and damage is increased.

(4) In addition, when a body section of the black box is separated from the camera, the body section, which is regardless of photographing, is also exposed to the inside with the camera. As a result, the interior design is further spoiled due to the unnecessary body section.

### SUMMARY OF THE INVENTION

In order to solve the problems, the present invention provides a headliner integrated with a camera of a black box for a vehicle configured such that the camera of the black box is accommodated in the headliner to minimally expose the black box to the inside of the vehicle, preventing robbery of or damage to the black box and not spoiling the interior design of the vehicle.

In particular, the present invention also provides a headliner integrated with a camera of a black box for a vehicle including four cameras installed at corners of the headliner to photograph required videos in front and rear, and both sides of the vehicle, obtaining videos of surroundings of the vehicle.

In addition, the present invention also provides a headliner integrated with a camera of a black box for a vehicle capable of photographing videos of surroundings of the vehicle and the inside thereof using the camera of the black box and thus simultaneously obtaining a basic function of the black box and a function of observing the inside of the vehicle.

In order to accomplish the object, the present invention is directed to providing a headliner integrated with a camera of a black box for a vehicle, which is installed at a roof panel of the vehicle, characterized in that the camera of the black box is installed at the headliner.

In particular, four cameras may be installed at the headliner to be disposed at corners of an inside ceiling of the vehicle. In addition, the camera may simultaneously photograph the inside and outside to display and store the photographed images.

Finally, the camera may have a photographing angle (θ) of 120 to 135°, the camera installed in the front of the vehicle may simultaneously photograph the front and the inside of the vehicle with respect to a reference line connecting an installation position thereof and an end of a bonnet, and the camera installed in the rear of the vehicle may simultaneously photograph the rear and the inside of the vehicle with respect to a reference line connecting an installation position thereof and an end of a trunk hood.

### BRIEF DESCRIPTION OF THE DRAWINGS

The above and other objects, features and advantages of the present invention will become more apparent to those of ordinary skill in the art by describing in detail example embodiments thereof with reference to the attached drawings, in which:

FIG. 1 is a conceptual plan view showing a vehicle to illustrate a mounting position and a photographing angle of a 4-channel black box according to the present invention;

FIG. 2 is a partial perspective view of a vehicle showing a state in which a camera of a black box according to the present invention is installed at a corner of a driver's seat;

FIG. 3 is a perspective view showing a partial configuration of a headliner at which the camera of the black box according to the present invention is installed; and

FIG. 4 is a conceptual view illustrating the entire photographing angle of the 4-channel black box according to the present invention.

### DETAILED DESCRIPTION OF EXAMPLE EMBODIMENTS

Hereinafter, an exemplary embodiment of the present invention will be described in detail with reference to the accompanying drawings. Terms used herein and the following claims should not be construed as being limited to a conventional or dictionary definition but as meanings and concepts coinciding with the technical spirit of the present invention based on the principle that the inventor could appropriately define concepts of the terms to describe the best mode of the invention.

Accordingly, it will be appreciated by those skilled in the art that the detailed description given herein with respect to these figures is for explanatory purposes as the invention extends beyond these limited embodiments, and various equivalents, modifications, and variations may be made in these embodiments without departing from the principles and spirit of the general inventive concept.

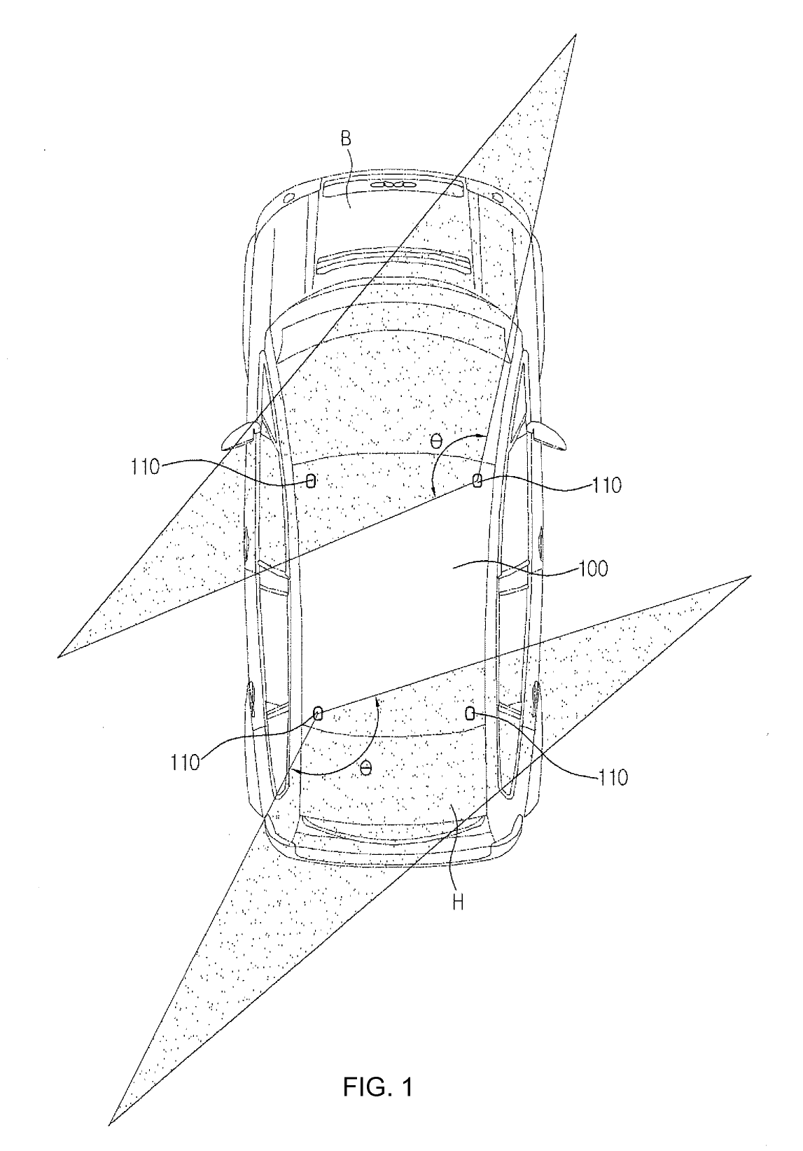

As shown in FIGS. 1 to 4, in a headliner 100 integrated with a camera of a black box for a vehicle according to the present invention, a camera 110 is previously installed at the headliner 100 and mounted on vehicle so that the black box can be mounted in the inside of the vehicle and exposure of the camera 110 to the inside can be minimized.

Hereinafter, such a configuration will be more specifically described as follows.

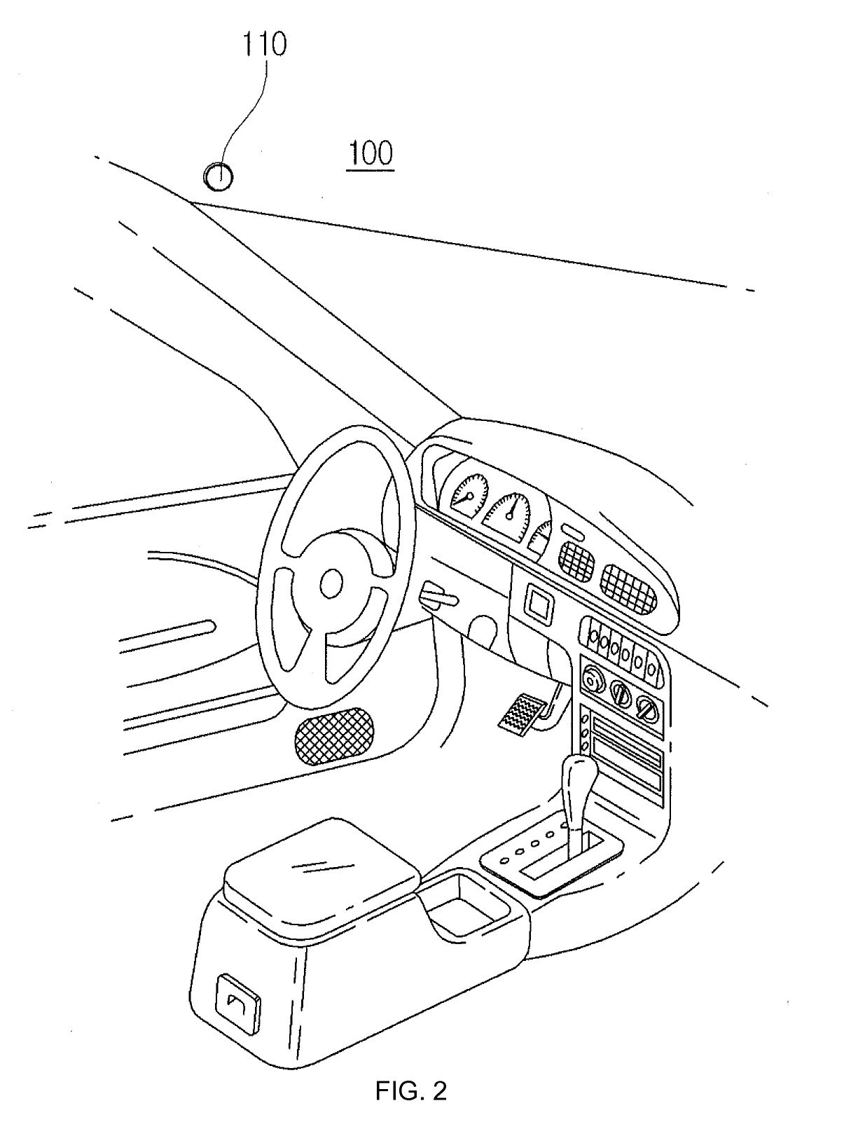

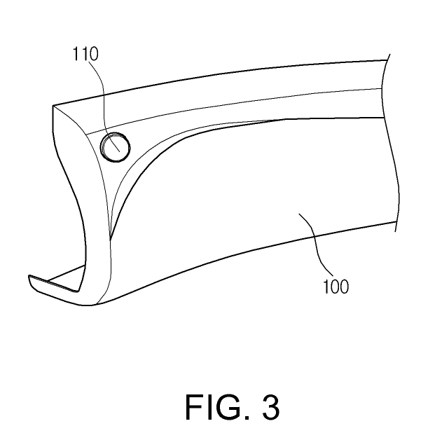

The headliner 100 is manufactured by a conventional technique. In particular, an installation space in which the camera 110 is to be installed is previously formed in the headliner 100 upon manufacture, and the camera 110 is seated on the installation space such that only a lens portion can be seen from the inside. This is provided to minimize the exposure of the camera 110 to the outside of the headliner 100. As shown in FIGS. 2 and 3, since the camera should be exposed to the outside to photograph, the camera is installed such that only a lens portion is exposed to the inside of the vehicle.

The camera 110 manufactured by a conventional technique is applied to the black box. The camera 110 is mounted in the installation space, which is previously formed upon manufacture of the headliner 100. Here, as described above, only the lens portion of the camera 110 may be configured to be exposed to the outside of the headliner 100.

In addition, while one to four cameras 110 may be installed at the headliner 100 according to a kind of a vehicle or requirements of a car buyer, the four cameras 110 may be installed as shown in FIG. 1.

Here, the cameras 110 are installed at corners of the inside ceiling when seen from the inside of the vehicle. As shown in FIG. 1, since the cameras 110 can simultaneously photograph the inside and outside of the vehicle, the cameras 110 can simultaneously perform a basic function of the black box and a function of observing the inside of the vehicle.

This will be more specifically described as follows.

The camera 110 of the present invention has a photographing angle θ of 120 to 135°. In addition, the camera 110 is installed at the headliner 100 such that the inside and outside of the vehicle can be photographed within a range of the photographing angle θ.

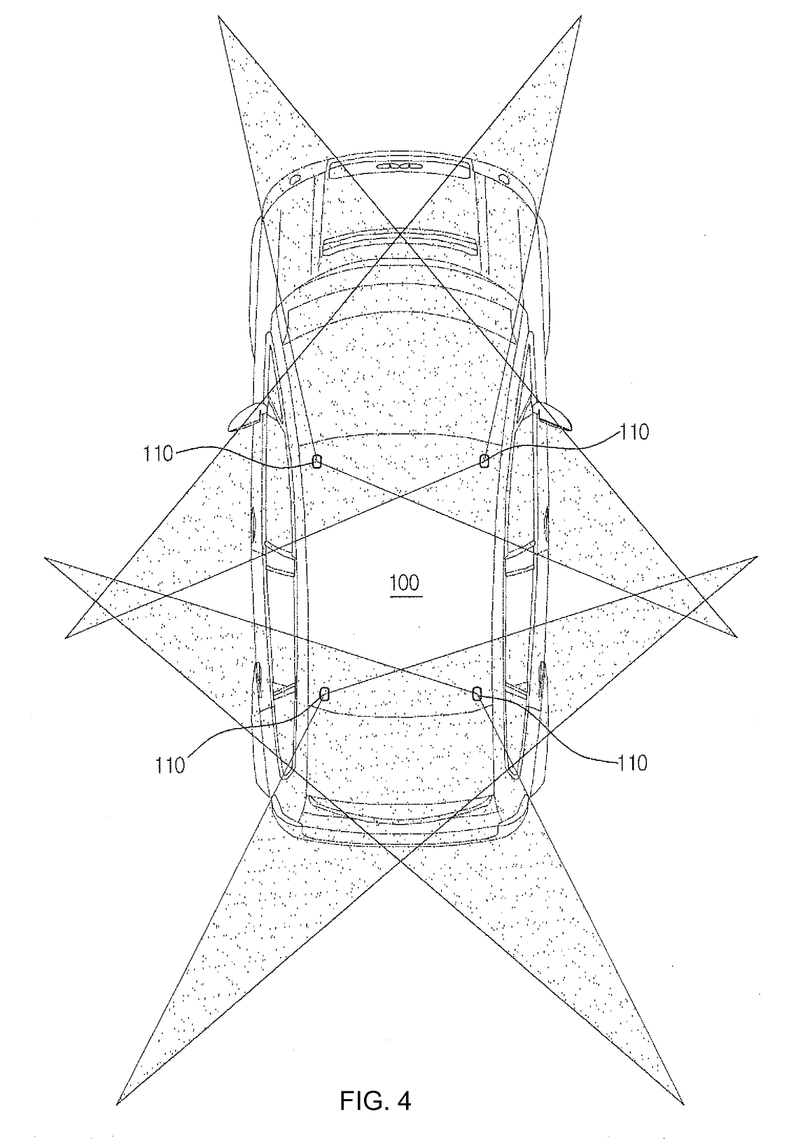

For example, as shown in FIGS. 1 and 4, when the camera is installed at the front of the headliner 100 to photograph the front, the camera photographs at an angle of 120 to 135° with respect to a reference line connecting a camera installation position and an end of a bonnet B so that the outside of the vehicle is photographed within a range of about 110° of the photographing angle θ with respect to the reference line and the inside of the vehicle is photographed within a residual range of about 10 to 25°.

In addition, when the camera of the black box is installed at the rear of the headliner 100 to photograph the rear, as shown in FIGS. 1 and 4, the camera photographs at the photographing angle θ of 120 to 135° with respect to a reference line connecting the camera installation position and an end of a trunk hood H. The camera can also simultaneously photograph the rear and the inside of the vehicle like the above-mentioned photographing of the front.

As shown in FIG. 4, the 4-channel type black box using the four cameras 110 according to the present invention can photograph videos of the surroundings and the inside of the vehicle and only a portion of the camera 110 can be exposed to the inside of the vehicle, even though small overlapping sections of the videos are present.

Meanwhile, in the exemplary embodiment of the present invention, when the cameras 110 configured to simultaneously photograph the inside and outside of the vehicle are integrally manufactured with the black box, the black box itself is mounted on the headliner 100. In addition, when the main body and the camera are separated from each other depending on the kind of the black box, only the camera section is mounted on the headliner and used.

Accordingly, the camera according to the present invention can photograph the surroundings including the front and the rear of the vehicle and also the inside of the vehicle to perform a function of a surveillance camera while minimizing exposure of the camera to the outside by the headliner.

As can be seen from the foregoing, according to the headliner integrated with a camera of a black box for a vehicle of the present invention, the following effects can be accomplished.

(1) Since the black box is mounted in the inside of the vehicle, the camera is not exposed to the outside of the vehicle to reduce probability of robbery of or damage to the black box (or the camera).

(2) Since the 4-channel block box provided with four cameras can photograph the entire surrounding of the vehicle, a blind spot can be reduced to improve running safety of a driver.

(3) Since the camera can photograph the inside of the vehicle as well as the surrounding thereof, the black box can perform a function of a surveillance camera in addition to a function of the black box.

(4) Since the camera of the black box is previously mounted in the headliner upon delivery of the vehicle, it is possible to remove inconvenience of separate purchase and installation of the black box.

(5) Since only the lens portion of the camera is exposed to the inside of the vehicle, an exposure portion of the black box to the inside of the vehicle can be minimized so that spoilage of the interior design of the vehicle can be minimized.

While the invention has been shown and described with reference to certain example embodiments thereof, it will be understood by those skilled in the art that various changes in form and details may be made therein without departing from the spirit and scope of the invention as defined by the appended claims.

What is claimed is:

1. A headliner integrated with a camera of a black box for a vehicle, which is installed at a roof panel of a vehicle, comprising a first camera installed at the headliner.

2. The headliner according to claim 1, wherein four cameras are installed at the headliner and disposed at corners of an inside ceiling of the vehicle.

3. The headliner according to claim 1, wherein the first camera is configured to simultaneously photograph an inside and an outside to produce photographed images, and to display and store the photographed images.

4. The headliner according to claim 3, wherein the first camera has a photographing angle of 120 to 135 degrees, and
The first camera installed in a front of the vehicle is configured to simultaneously photograph the front and the inside of the vehicle with respect to a first reference line connecting a first installation position of the first camera and an end of a bonnet, and a second camera installed in a rear of the vehicle is configured to simultaneously photograph the rear and the inside of the vehicle with respect to a second reference line connecting a second installation position of the second camera and an end of a trunk hood.

5. The headliner according to claim 4, wherein the second camera has a photographing angle of 120 to 135 degrees.
